(19) United States
(12) Patent Application Publication
(10) Pub. No.: US 2005/0241649 A1
(43) Pub. Date: Nov. 3, 2005

(54) Intraoral weight-control appliance

(76) Inventor: James R. Strait, Marietta, GA (US)

Correspondence Address: CHRISTIE, PARKER & HALE, LLP, PO BOX 7068, PASADENA, CA, 91109-7068, US

(21) Appl. No.: 10/834,492

(22) Filed: Apr. 28, 2004

(51) Int. Cl. A61C 3/00; A61C 5/14

(52) U.S. Cl. 128/859

(57) ABSTRACT

An intraoral weight-control appliance for mounting on a patient's molar teeth, and extending in a fixed position around an inner or lingual surface of teeth of the maxillary dental arch. Lattice-like openings in the appliance permit ingestion of liquids and small-particle foods, but blocks solid foods as an aid to weight reduction. Hinged tooth bands of the appliance enable easy installation over opposed nonparallel molars of the upper arch.

### BACKGROUND OF THE INVENTION

This invention is directed to a weight-control appliance for mounting on a user's teeth to impede swallowing of solid foods, while permitting ingestion of liquids and small particulate foods. It is believed effective in achieving weight reduction of obese individuals lacking will power to avoid excessive food consumption.

Intraoral devices with the, same objective are disclosed in U.S. Pat. Nos. 4,471,771 and 4,738,259. These patents discuss in detail the health problems of obese people, and various approaches which have been taken to limit food ingestion to achieve weight loss. For brevity, the disclosures of these patents are incorporated herein by reference.

The improved appliance of the present invention extends around the lingual side of the teeth of the maxillary or upper jaw. The appliance is supported by tooth bands fitted over the opposed first molars, these attachment points being hinged or pivoted to enable installation on first molars with nonparallel axes. A lattice-like appliance structure interferes with the ingestion of solid foods by blocking transfer from the chewing area of the mouth into the tongue or swallowing area of the oral cavity. Liquids and small-particle foods are not so blocked, and foods not requiring chewing can also be ingested. The appliance requires users to plan their meals, and thus controls the quantity and quality of food intake. Impulse eating of solid foods, however, is discouraged, and the appliance will achieve weight reduction. The appliance does not interfere with brushing, flossing, and rinsing of the teeth for good oral hygiene.

### SUMMARY OF THE INVENTION

An intraoral weight-control appliance configured to extend around an inner lingual surface of patient's upper dental arch, and mounted in a fixed position by a pair of tooth bands secured to the opposed upper first-molar teeth. The appliance extends beneath an occlusal plane of the upper teeth, and blocks ingestion of solid foods, but has openings which can admit liquids and small-particle foods. The tooth bands are preferably movably mounted to enable fitting over nonparallel first molars during appliance installation. The appliance preferably includes occlusal rest bars configured to rest on the patient's opposed upper first-bicuspid teeth to further stabilize the appliance in a fixed position.

### DESCRIPTION OF THE DRAWINGS

FIG. 1 is an inverted perspective view of the appliance, as inverted from an actual-use position;

FIG. 2 is a top view of the appliance of FIG. 1;

FIG. 3 is a side view;

FIG. 4 is a view on line 4-4 of FIG. 2 showing a hinge connection of a tooth band;

FIG. 5 is an inverted view of the appliance as seated on a model of an upper dental arch; and

FIG. 6 is a side sectional view taken on line 6-6 of FIG. 5.

### DESCRIPTION OF THE PREFERRED EMBODIMENT

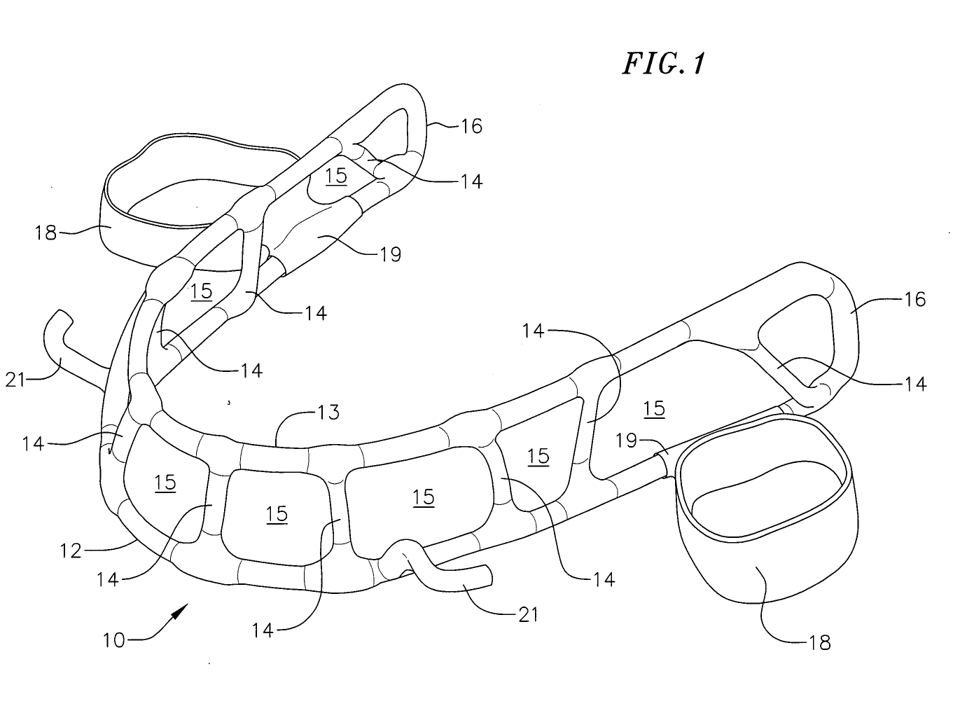

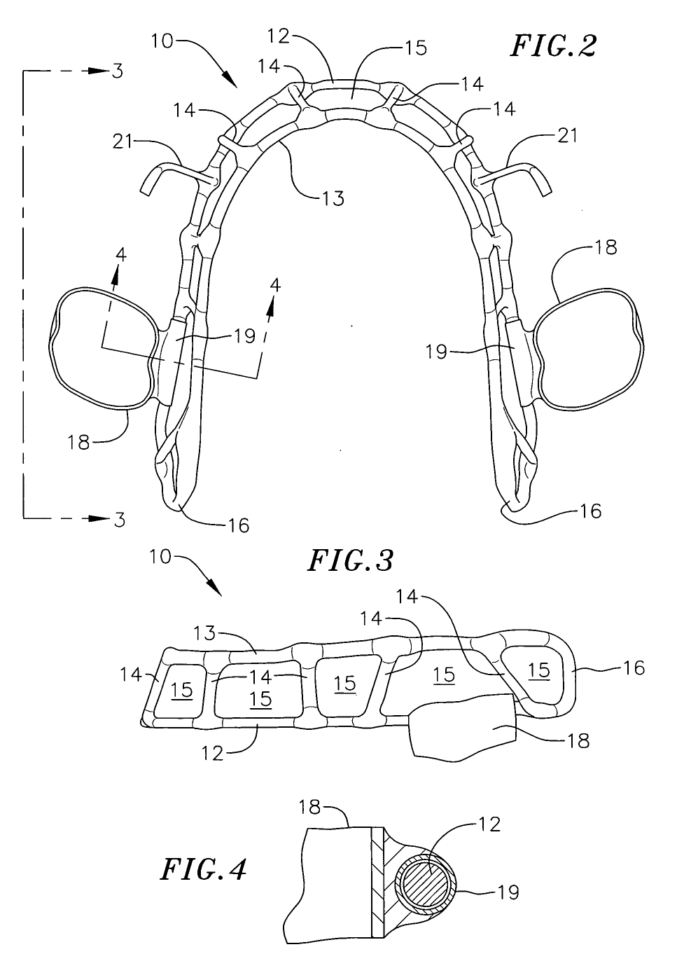

FIGS. 1-4 illustrate an intraoral weight-control appliance 10 according to the invention, and configured to extend around inner or lingual surfaces of teeth of an upper maxillary dental arch. The appliance is a silver-soldered assembly of components largely made of stainless-steel wire, typically of about 0.045-inch diameter.

The appliance components include an upper palatal bar 12, and a lower occlusal bar 13, both somewhat U-shaped to conform to the inner curvature of the upper dental arch. A forwardly central part of the palatal bar extends forwardly of a corresponding part of the occlusal bar as shown in the drawings. A plurality of short transverse struts 14 are silver soldered to, and rigidly interconnect bars 12 and 13. Struts 14 are spaced apart by about six millimeters to form openings 15 permitting ingress of liquids and small-particle foods. Rear or distal ends of bars 12 and 13 are interconnected by curved rear struts 16 soldered thereto.

The appliance is intended for mounting on first molar teeth of the upper arch, and is accordingly fitted with a pair of stainless-steel tooth bands 18 (similar to those used in the practice of orthodontics) configured to fit over and be cemented to these teeth. An inner or lingual surface of each band 18 is soldered to a stainless-steel tube 19 which makes a rotatable slip fit on upper bar 12, and is fitted over the upper bar before the rear struts are secured in place. This provides a hinged connection of the tooth bands to the lower bar, enabling fitting of the bands over nonparallel opposed first molars which are frequently encountered.

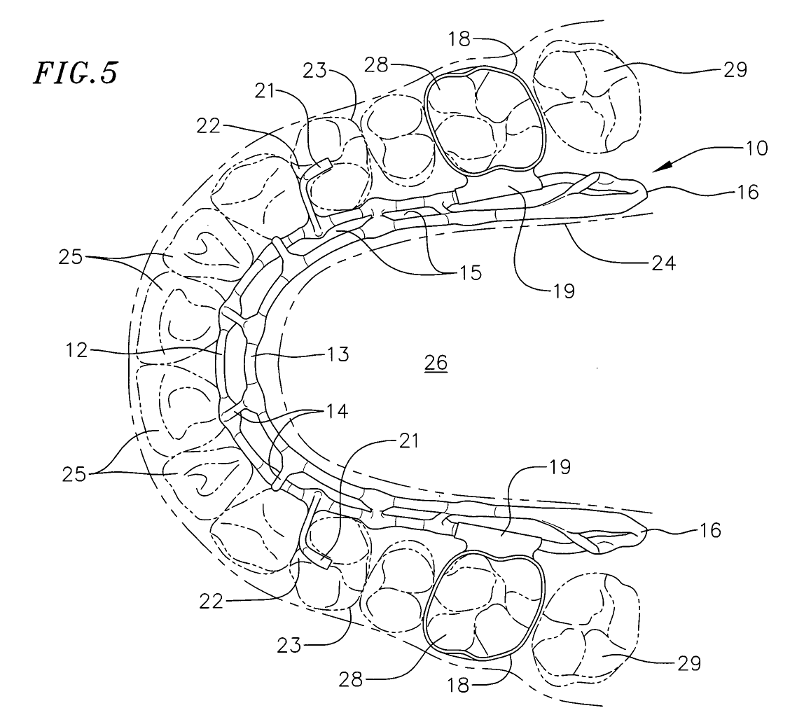

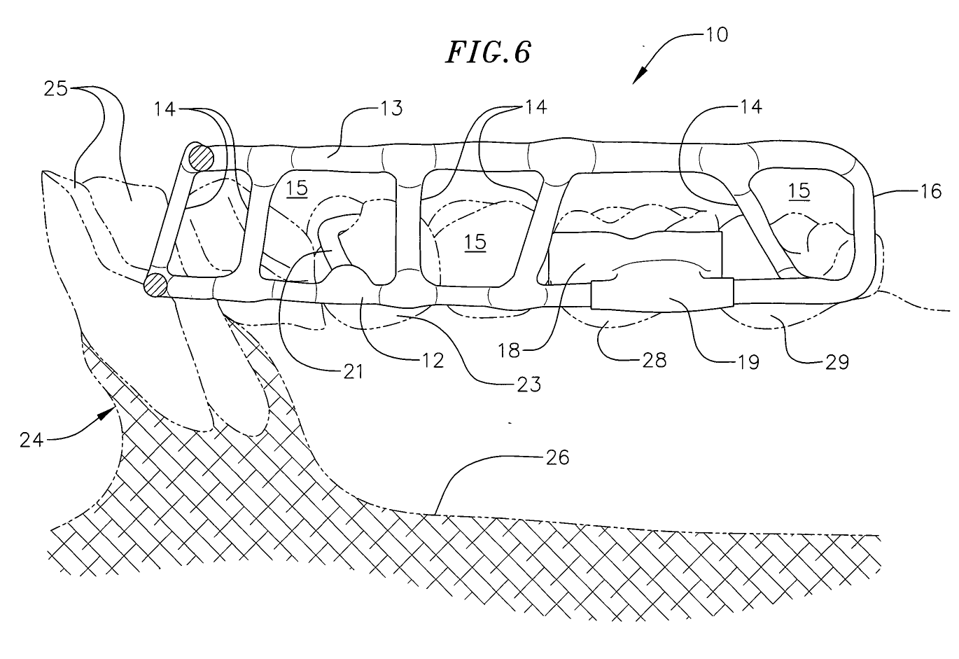

To further stabilize the installed appliance, short occlusal-rest bars 21, made of stainless-steel wire of about 0.028-inch diameter, are silver soldered to opposite sides of a forward part of upper palatal bar 12. Bars 21 extend buccally from bar 12 to be positioned on a mesial-occlusal surface 22 of each maxillary first bicuspid 23 (FIG. 5). Tooth bands 18 and bars 21 provide a stable four-point support system for the installed appliance.

To accommodate variations in dental-arch shapes and tooth positions, the appliance is custom made for each user. A conventional impression is taken of the upper dental arch, and a plaster or stone model is made from the impression. A typical such model 24 is shown (in inverted position) in FIGS. 5 and 6, with the appliance fitted thereon, thus simulating appliance installation in a patient's mouth.

The appliance is configured so palatal bar 12 is spaced rearwardly about 3 millimeters from lingual faces of central and lateral incisors 25, and is spaced apart beneath palate 26 about two millimeters. A forward part of occlusal bar 13 is about level with the incisal edges of the anterior teeth, and slopes upwardly and rearwardly to be spaced above first and second molars 28 and 29 about 4 millimeters. Slight lingual spacing of the occusal bar from lingual surfaces of the posterior teeth permits normal occlusion of the upper and lower teeth when closed together. Occlusal-rest bars 21 are shown positioned as described above against first bicuspids 23.

When installed in the patient's mouth, with tooth bands 18 cemented to the first molars, the hinging action of tube 19 is locked, and the appliance is fixed in position to block ingestion of solid foods. The appliance extends below the occlusal plane of the maxillary teeth, forming a latticed gate or fence blocking ingestion of solid foods. The appliance is not prominently visible to others, and does not interfere with breathing, swallowing, talking, or drinking, but provides a constant reminder to plan and consume proper nutrition aimed at weight loss. The appliance also stimulates production of saliva, which further reduces hunger sensations. Soldered construction eliminates need for casting procedures, but provides a strong and stable appliance for effective weight reduction.

1. An intraoral weight-control dental appliance configured for fixed mounting on a patient's opposed maxillary upper molar teeth, and to extend around an inner lingual surface of the patient's upper dental arch, the mounted appliance extending below an occlusal plane of the upper arch, and having spaces admitting liquids and small-particle foods, but blocking ingestion of solid foods.

2. The appliance of claim 1, wherein the appliance comprises spaced-apart upper-palatal and lower-occlusal bars, and a plurality of spaced-apart struts secured to and joining the bars, the bars and struts defining said spaces.

3. The appliance of claim 2, and further comprising a pair of spaced-apart tooth bands positioned adjacent opposed distal ends of the appliance, and configured for mounting on the patent's upper first-molar teeth, the tooth bands being connected to the lower-occlusal bar.

4. The appliance defined in claim 3, wherein the tooth bands are hinged to the lower-occlusal bar to be movable with respect to the lower-occlusal bar during appliance installation, and thereafter fixed in position.

5. The appliance defined in claim 4, and further comprising a pair of spaced-apart occlusal-rest bars secured to and extending lingually from the lower-occlusal bar to rest on mesial-occlusal surfaces of the patient's opposed maxillary first bicuspid teeth, thereby further stabilizing the appliance in a fixed position.

6. The appliance of claim 5, wherein the bars and struts are made of stainless-steel wire.

7. The appliance of claim 6, wherein the bars and struts are soldered together.
